(19) United States
(12) Patent Application Publication
(10) Pub. No.: US 2014/0196002 A1
(43) Pub. Date: Jul. 10, 2014

(54) TOOL AND METHOD THEREOF FOR EFFICIENT DESIGN OF INFORMATION TECHNOLOGY SYSTEMS

(71) Applicant: Shahak SHEFER, Hod Hasharon (IL)

(72) Inventor: Shahak SHEFER, Hod Hasharon (IL)

(21) Appl. No.: 14/149,037

(22) Filed: Jan. 7, 2014

Related U.S. Application Data
(60) Provisional application No. 61/750,012, filed on Jan. 8, 2013.

(51) Int. Cl. G06F 9/44

(52) U.S. Cl. CPC G06F 8/20; G06F 8/10
USPC 717/104

(57) ABSTRACT

A design tool and method for designing information technology (IT) systems are provided. The method includes receiving at least one requirement for the IT system; receiving a layout of the IT system; extracting the at least one requirement and the layout; classifying the at least one requirement; selecting a design pattern respective of each of the at least one classified requirement and the layout; linking each of the at least one classified requirement to at least one design dimension; producing an at least one complete design of the IT system; and querying a user to determine whether the at least one complete design of the IT system has been approved by the user.

### CROSS REFERENCE TO RELATED APPLICATIONS

This application claims the benefit of U.S. provisional application No. 61/750,012 filed on Jan. 8, 2013, the contents of which are herein incorporated by reference.

### TECHNICAL FIELD

The present invention relates to information technology (IT) systems, and particularly to solutions for efficient design of IT systems.

### BACKGROUND

Developing an IT system requires designing a system that meets specified business, system, and component functional and non-functional requirements. The known solutions for designing, developing, managing, and deploying IT systems are costly, involve excessively long development cycles, and are marked by performance and stability problems.

Prior to the development of an IT system, an IT analyst or information systems (IS) analyst analyzes the business requirements and the technical specifications of the IT system to be designed. Then the developmental process begins, utilizing the artifacts from the analysis. In a typical developmental process of an IT system, developers and system integrators often use tools to develop and manage the application architecture to solve the business needs of a customer. The business, system, and component functional and non-functional requirements are identified to facilitate the design. These requirements are then typically generated as requirements documents. Thereafter, a modeling tool is used to provide system-contextual diagrams, component models, deployment models, and data flow diagrams. Code is then programmed to realize the output of the modeling tools. The code is saved in a repository for later deployment.

An infrastructure information technology architect then designs the physical environment, i.e., servers, databases, and networks, to run the code and store the data captured and maintained by the IT system. Many techniques are discussed in the related art to validate that the requirements are being met during the development cycle of an IT system. Such techniques include, for example, testing the IT system in a test environment, modeling capacity and performance via simulations, testing a prototype of the system in the physical environment, and so on. In the deployment cycle, a system engineer builds the run-time environment (e.g., installs and configures switches, servers, operating systems, etc.) and then installs the software package comprised of the generated code.

In the conventional techniques for developing an IT system, the respective design processes involving the customer and involving the infrastructure IT architect (or IS analyst) are disjointed, resulting in very low project success rates, inflexible system components and significant costs related to lengthy design and deployment times. Furthermore, the disjointedness between the design processes makes it difficult to identify and manage the impact of a single requirement, or of a change in a requirement, in real time prior to the phase of deploying the IT system, and even more so after the deployment. Moreover, numerous iterations occur between the customer and the developer until the generated models meet the requirements. Each such iteration requires re-writing the requirements documents and creating a modeling process based on these documents. Further, the customer is required to read and understand vast quantities of written professional material. Consequently, in the conventional techniques for developing an IT system, the customer cannot fully understand how a requirement that was originally defined or later added/modified can affect the overall performance of the newly deployed IT system.

It would therefore be advantageous to provide an efficient solution that overcomes the deficiencies of conventional techniques for planning and developing IT systems.

### SUMMARY

Certain embodiments disclosed herein include a method for designing an information technology (IT) system. The method comprises receiving at least one requirement for the IT system; receiving a layout of the IT system; extracting the at least one requirement and the layout; classifying the at least one requirement; selecting a design pattern respective of each of the at least one classified requirement and the layout; linking each of the at least one classified requirement to at least one design dimension; producing an at least one complete design of the IT system; and querying a user to determine whether the at least one complete design of the IT system has been approved by the user.

Certain embodiments disclosed herein also include a design tool for designing an information technology (IT) system. The design tool comprises a interface configured to receive at least one input requirement and a layout of the IT system to be designed; a processor; a memory connected to the processor and configured to contain a plurality of instructions that, when executed by the processor, configure the system to: extract the at least one requirement and the layout; classify the at least one requirement; select a design pattern respective of each of the at least one requirement and the layout; link the at least one requirement to at least one design dimension; and produce at least one optimized design pattern.

### BRIEF DESCRIPTION OF THE DRAWINGS

The subject matter that is regarded as the invention is particularly pointed out and distinctly claimed in the claims at the conclusion of the specification. The foregoing and other objects, features, and advantages of the invention will be apparent from the following detailed description taken in conjunction with the accompanying drawings.

FIG. 1 illustrates a block diagram of an IT system design tool according to one embodiment.

FIG. 2 is a hierarchical representation of requirements classified by the disclosed tool.

FIG. 3 is a diagram showing the relationship between data entities maintained by the disclosed tool according to one embodiment.

FIG. 4A is an exemplary screenshot generated by the design tool of a hierarchical representation of requirements classified by the design tool.

FIG. 4B is an exemplary screenshot generated by the design tool demonstrating database tables designed to correspond to requirements generated by an analyzer.

FIG. 4C is an exemplary screenshot generated by the design tool of customer information organized by the design tool.

FIG. 4D is an exemplary screenshot generated by the design tool of the navigation display presented to a user upon selection of a particular input field.

FIG. 5 is a flowchart illustrating a method for efficient design of IT systems according to one embodiment.

### DETAILED DESCRIPTION

The embodiments disclosed herein are only examples of the many possible advantageous uses and implementations of the innovative teachings presented herein. In general, statements made in the specification of the present application do not necessarily limit any of the various claimed inventions. Moreover, some statements may apply to some inventive features but not to others. In general, unless otherwise indicated, singular elements may be in plural and vice versa with no loss of generality. In the drawings, like numerals refer to like parts through several views.

Certain embodiments disclosed herein include a tool and method for designing IT systems. The tool allows users to take an active role in the design process that is enabled by the intuitive design features of the tool. Further, the tool disclosed herein allows the users to easily understand how any requirement can impact the system's overall performance including, but not limited to, the organizational implications of the IT system during the design and deployment cycles. A user of the disclosed tool may be a developer, a system architect, an end-user (i.e., a person using the IT system), and a customer (i.e., an IT manager at an organization that ordered the system). In a preferred embodiment, the disclosed tool is highly advantageous to system architects who plan and design IT systems.

In one embodiment, during the design cycle, the tool generates displays of the IT system in real-time, enabling the users to view the components of the IT system to be developed and to make the necessary changes prior to development early in the design cycle. Thus, the disclosed tool provides greater flexibility in the design process, eventually leading to shorter development cycles. In one embodiment, the generated displays include dimensional views of the IT system including, but not limited to, a simulation of an IT system, a user experience and layout design mode, graphic dynamic displays and interfaces of navigation, menus and database design, hierarchal displays and interfaces of the requirements, business vocabulary, actions, users and roles, and action items. The simulation of the designed IT system provides the actual screens that would be displayed to end-users of the system such as, for example, screens through which end-users can view, engage and manage the information of the system.

The tool for designing an IT system generates a package containing at least detailed design documents describing the system context diagrams, component models, and deployment models created during the design cycle. The design documents can be used to program the code, thereby realizing the IT system. In one embodiment, the package also contains detailed documents describing optimized deployment conditions and testing instructions for the IT system, as well as training information and system documentation.

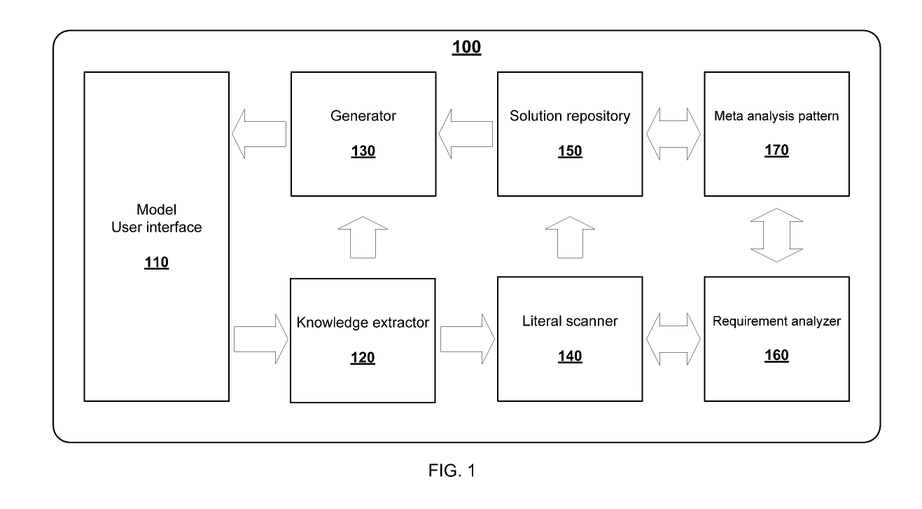

FIG. 1 shows an exemplary and non-limiting block diagram of an IT system design tool 100 according to one embodiment. The tool 100 includes a user interface 110, a knowledge extractor 120, a generator 130, a literal scanner 140, a solution repository 150, a requirement analyzer 160, and a meta-analysis pattern module 170.

The user interface 110 allows the various users to interact with the tool 100. The user provides the requirements of the IT system to be designed through the interface 110, and can view the various modules and layout of the system through various displays generated by the tool 100. Exemplary and non-limiting screenshots of the displays generated by the tool 100 are provided below. A user (e.g., a system architect) utilizes the interface 100 to analyze the input requirements, to modify the requirements, or to provide their own requirements and to enter information required for the design process. Such information may be related to one or more analysis dimensions including, but not limited to, information entities (entities, properties, and meta-data), user experience (forms, commands and navigations), organization structure (users, roles and authorizations), actions, and action items. In one embodiment, the user provides a list of action items that should be performed in order to complete the project through the interface 100. In a preferred embodiment, a system architect provides the proper inputs to the tool, and the IT manager reviews a simulation of the designed IT system.

The knowledge extractor 120 performs two functions, including extractions of inputs provided by a user of the tool. Such inputs include, but are not limited to, requirements, menus, screens, labels, and controls in the input layer. The controls may be in a form of command buttons (e.g., a SUBMIT button), drop-down menus, and the like. The controls are ordered according to the layout screens at which they appear. The extracted requirements are fed to the literal scanner 140 and the extracted controls are fed to the generator 130.

An input requirement provided by a user may include a commonly-used requirement (e.g., “client,” as in “a system for managing clients and client related information”) or a proprietary requirement (e.g., “service seeker”). The tool 100 distinguishes between these types of requirements by means of the literal scanner 140 and the requirement analyzer 160. Specifically, the literal scanner 140 performs textual analysis of the extracted information to determine if each requirement in the input provided by the user is a recognized requirement. The detected requirement(s) are fed to the requirement analyzer 160. The requirement analyzer 160 determines if the fed requirements can be associated with “IT professional concepts.” An IT professional concept is an object commonly used in an IT system. For example, an IT professional concept may be a human entity such as a user or a client, a system, a screen or button, or an IT-related concept such as an algorithm, process, business logic, actions, etc. The requirement analyzer 160 further classifies and optimizes each of the fed requirements.

In one embodiment, the requirement analyzer 160 classifies a requirement as a design dimension of the IT system, e.g., hardware type, GUI, database, training, security, etc. During the classification of requirements, a distinct requirement is classified as a requirement that is associated with only one design dimension. For example, a classified and distinct requirement may be “shoe size,” which may be associated with a design dimension “client”.

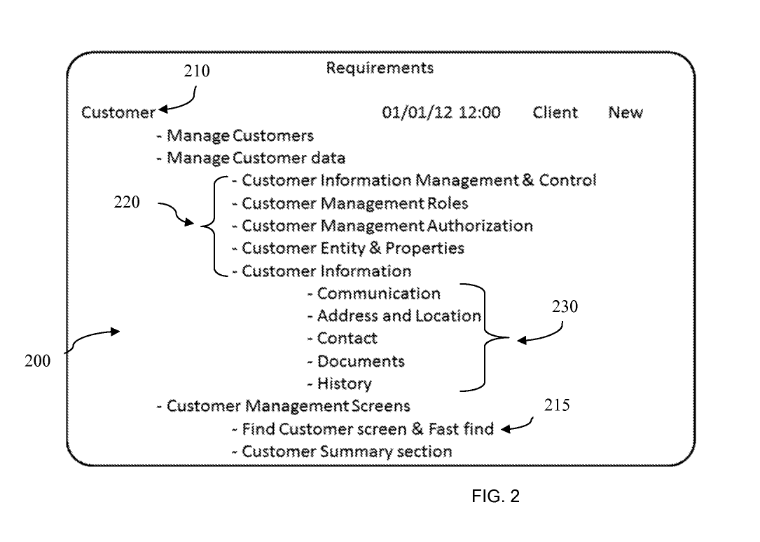

An optimized requirement is classified as a requirement that can be associated with a single development action. The respective optimized requirement may be associated with the action of adding a “shoe size” control to the client management screen or adding a “shoe size” field to a “client” table. The requirements can also be classified according to the type of user that provides the requirement. In one embodiment, the requirements are hierarchically displayed as provided in the exemplary screenshot shown in FIG. 2.

As depicted in FIG. 2, the root has a list of requirements 200 that includes an input requirement 210 (in this example, an input requirement 210 is “customer”) and the children are either classified requirements 220, distinct requirements 230, or optimized requirements 215. For example, the requirement “Address and Location” is a distinct requirement 230 of “customer information,” a classified requirement 220, and “Find Customer screen & Fast Find” is an optimized requirement 215. It should be appreciated that all of the classified requirements 220, distinct requirements 230, and optimized requirements 215 are automatically populated by the requirement analyzer 160. It should be further appreciated that the analyzer 160 allows comprehension and interpretation of any requirement provided by the user. Based on the interpretation, the requirements can be linked to component models of the IT system.

In one embodiment, the requirement analyzer 160 communicates with an IT concept dictionary (not shown) that contains a glossary of professional concepts. The analyzer 160 utilizes the IT concept dictionary to create and maintain a complete and hierarchal professional concepts dictionary in order to understand and interpret the input requirements. For example, professional concepts include GUI, screens, information, etc., as defined by IT professionals and architects.

The meta-analysis pattern module 170 includes fragmented design patterns of IT systems which can be utilized and modified to meet the requirements of the new IT system to be designed. The design patterns include well-defined and cross-dimensional linked entities of the IT system. The entities that are to be part of the new IT system are selected by the requirement analyzer, modified based on the requirements and the identified professional IT concepts, and then transferred to the solution repository to be used as design templates throughout the planning process. The module 170 further provides links between the selected entities and the requirements, which are transferred to the solution repository 150 as well.

According to an embodiment, the module 170 selects the design patterns based on the requirements provided by the requirement analyzer 160. With this aim, the module 170 processes the requirements provided by the analyzer 160 and determines which design patterns should be utilized in the IT system. For example, for the classified and distinct requirement “shoe size” associated with a design dimension “client,” the module 170 may select a database table, which is one form (or a part) of a design pattern in the database dimension “client,” and then links fields and properties associated with the requirements provided by the requirements analyzer 160 to the table, such as a client's name and shoe size entries. Respective of the optimized requirement “add a shoe size,” a screen, which is one form (or a part) of a design pattern in the GUI dimension with a drop-down menu control, relays instructions to choose a shoe size to the user and provides the user with the ability to select an “add” button (control). The design templates are saved in the solution repository 150.

The solution repository 150 records the various classes and types of requirements. Specifically, the solution repository 150 links each input requirement to its respective classified and optimized requirements as well as to at least one design template. Furthermore, the solution repository 150 identifies design dimensions and their properties, each linked to the optimized requirements. The dimensions' properties may include, but are not limited to, type, sub-type, level, priority, origin, stage, span, amount, frequency, timing, input, output, mandatory, counter, activity, visibility, position, pointer, severity, probability, completeness percentage, approval status, status, and so on.

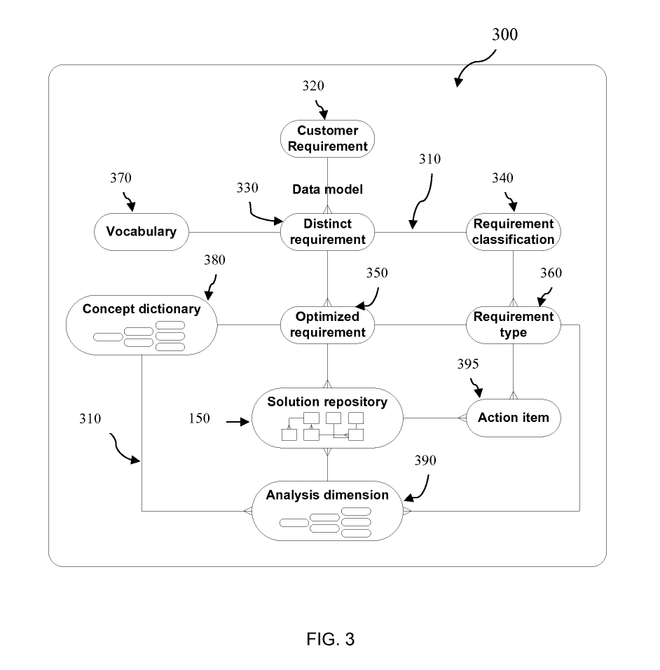

FIG. 3 illustrates a network of logical connections 300 among various sets of information according to an embodiment. In that embodiment, the solution repository 150 manages a database of logical connections 310 among the customer input requirements 320, distinct requirements 330, classified requirements 340, optimized requirements 350, requirement types 360, design dimensions, dimensions' properties, and a human dictionary 370 containing the vocabulary of the system. The human dictionary contains business terms and the like utilized to describe at least data entities, labels, screens, and the like of the IT system in a human language understandable by a user of the system.

In the embodiment illustrated by FIG. 3, the solution repository 150 may also contain logical connectors to a concept dictionary 380 that contains a glossary of professional concepts. For example, professional concepts may include, but are not limited to, GUIs, screens, information, etc., as defined by IT professionals and architects. The concept dictionary 380 can be used to create and maintain a complete and hierarchical list of professional concepts that facilitates understanding and interpretation of the customer input requirements 320.

According to the embodiment shown in FIG. 3, the solution repository 150 may also include logical connectors to analysis dimensions 390. Analysis dimensions may include information related to, but not limited to, information entities (entities, properties, and meta-data), user experience (forms, commands, and navigations), organization structure (users, roles, and authorizations), actions, and action items 395. The action items 395 may include, but are not limited to, a list of input requirements that should be processed by the tool 100 such as business vocabulary definitions, and/or a list of tasks that should be completed before a version of an IT system is issued, such as specific questions, choices, and decisions to be made.

The generator 130 generates and manages the versions of the designed IT system. A version is generated once the content of the solution repository 150 is updated. Once a version of a design of the IT system has been established, the various screens generated by the tool 100 are displayed over the user interface 110. In one embodiment, the generator 130 monitors the action items provided by the user and the approval status of each requirement.

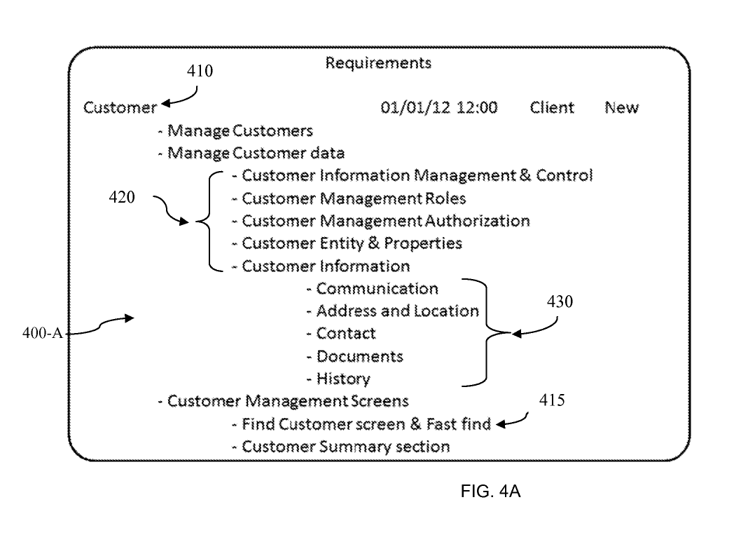

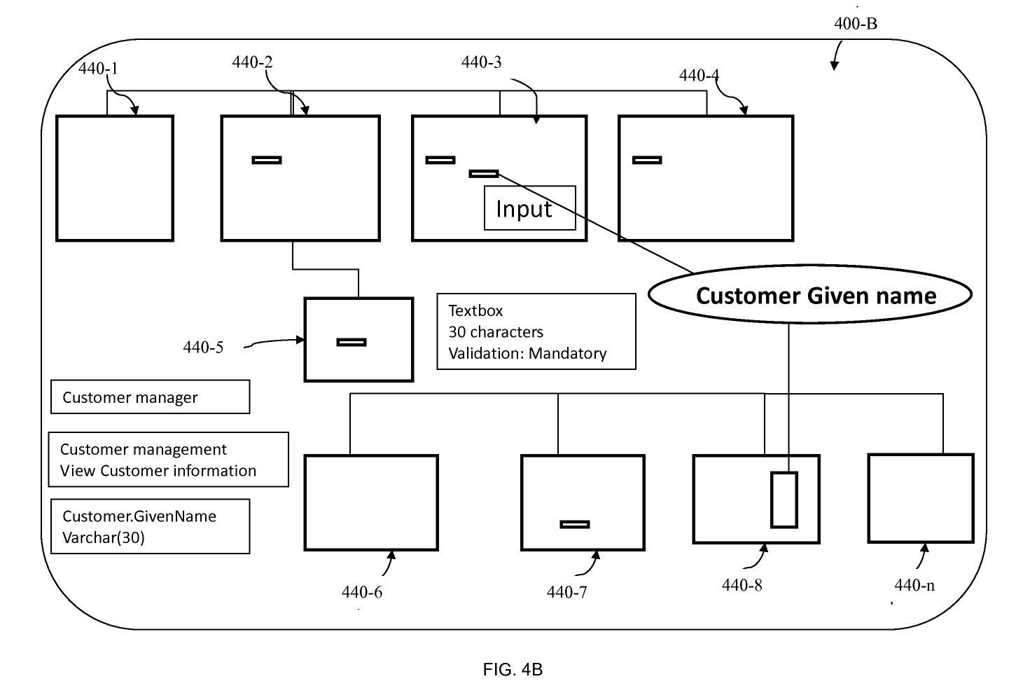

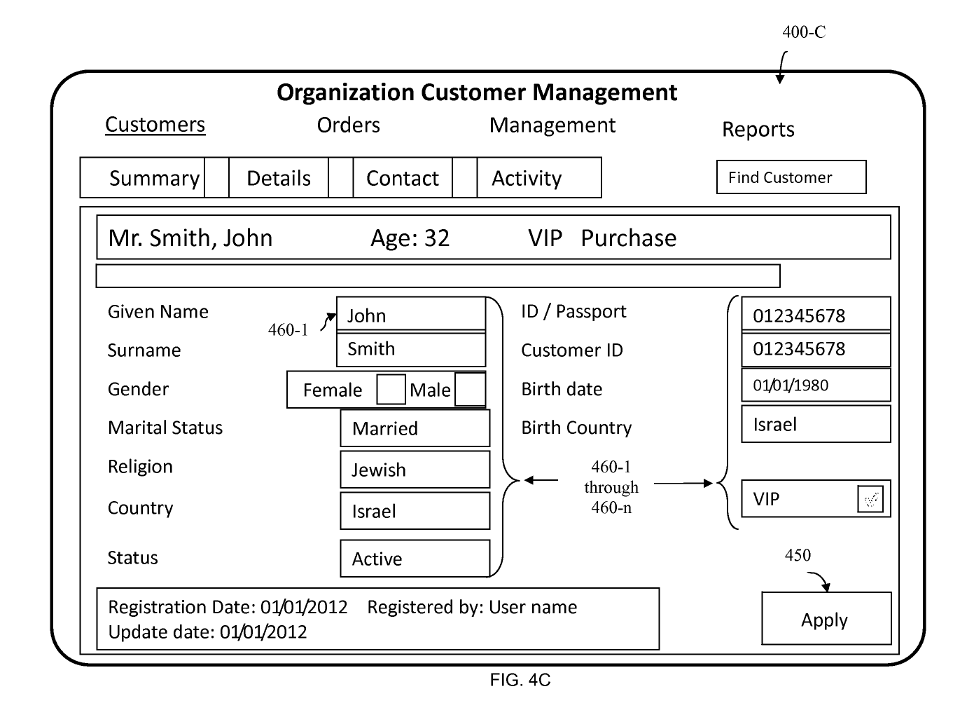

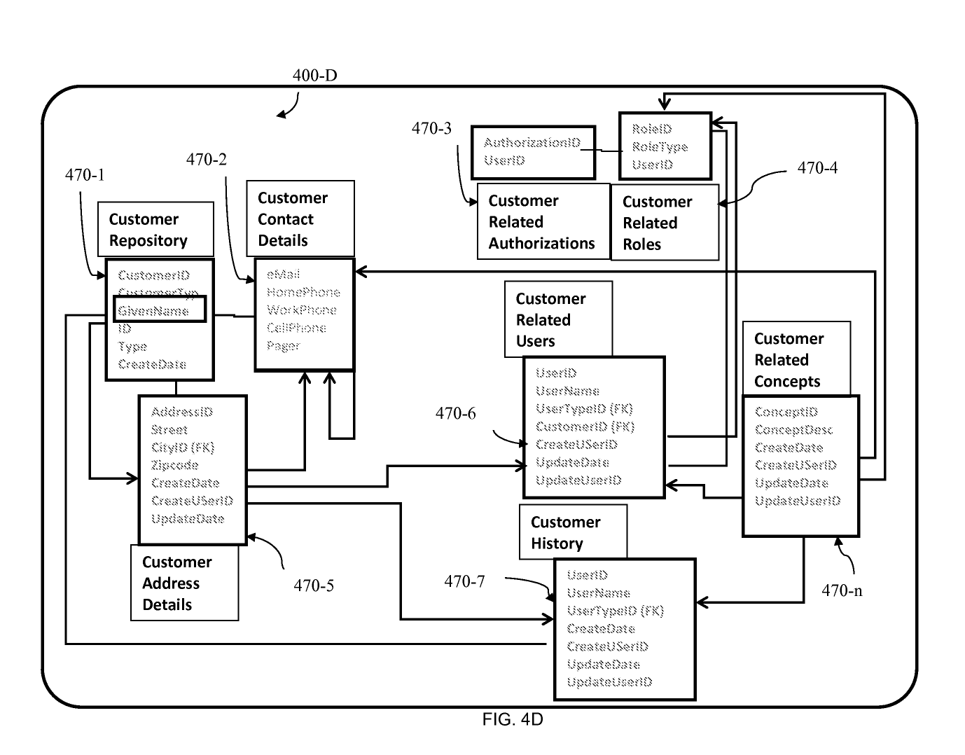

The following is a non-limiting example illustrating the operation of the design process as facilitated by the tool 100 and described with reference to the non-limiting and exemplary screenshots provided in FIGS. 4A through 4D. In this example, the list of requirements 400-A includes input requirement 410, which is, for example, “customer.” The input requirement 410 is identified by the literal scanner 140 and then fed to the requirement analyzer 160. The requirement analyzer 160 generates a list of related requirements including the linked classified requirements 420, distinct requirements 430, and optimized requirements 415 as shown in FIG. 4A. For example, the requirement “Address and Location” is a distinct requirement 430 of the classified requirement 420 “customer information,” and the requirement “Find Customer screen & Fast Find” is an optimized requirement 415 that is associated with a single development action.

The list of requirements generated by the analyzer 160 is input to the module 170 that subsequently selects the design patterns based on information entities associated with the requirements provided by the analyzer 160, and transfers these patterns as design templates to the solution repository 150. FIG. 4B shows database tables 400-B utilized as templates designed to correspond to the requirements generated by the analyzer 160. The design templates also include screens 440-1 through 440-n through which the user of the IT system interacts. For example, an exemplary screen 400-C through which a customer's information is entered is shown in FIG. 4C. The action button “Apply” is a control 450, and each of the input fields 460-1 through 460-n, e.g., “Given Name” (460-1), is associated with at least one respective distinct requirement. The tool 100 generates a list of screens 440-1 through 440-n that are linked through one or more information entities, allowing the user to easily navigate through the different screens and simulate all the related processes. For example, as shown in FIG. 4D, when a user (e.g., the IT architect) clicks on the input field “Given Name” (460-1), all screens that include this field 470-1 through 470-n across different information entities are displayed.

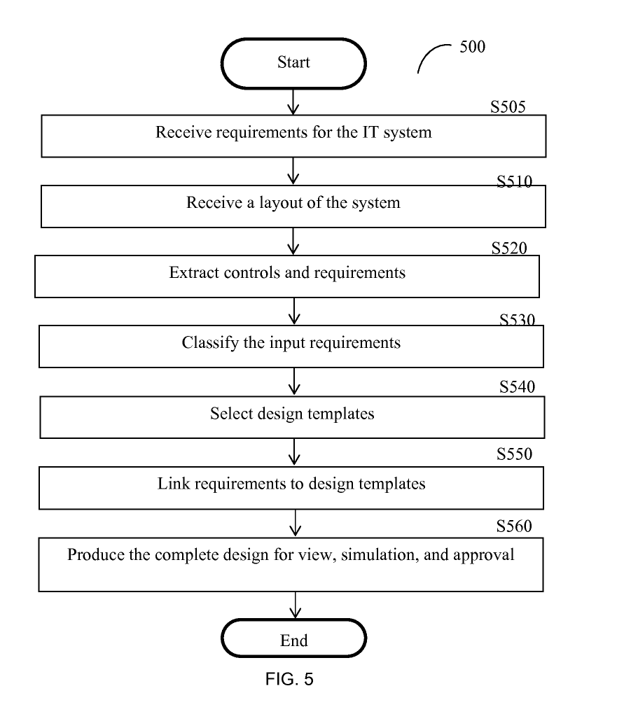

FIG. 5 is an exemplary and non-limiting flowchart 500 illustrating a method for efficient design of IT systems according to one embodiment. In one embodiment, the method is performed by the tool 100 discussed with reference to FIG. 1.

At S505, one or more requirements for the IT system are provided as an input. The requirements may include component function and non-function requirements, and can be provided by any user of the system, e.g., an end-client, a user, or a system architect. It should be noted that the requirements may be new to the tool, or an updated version of a previously received requirement. At S510, a layout of an IT system to be designed is received. The layout defines the interfaces between the IT system and a user of the system (e.g., buttons, background colors, logos, and the like).

At S520, the requirements and layout are extracted and fed to the literal scanner 140 and solution generator 130. In one embodiment, the extracted requirements are fed to the literal scanner 140 and the controls as provided in the extracted layout are fed to the solution generator 130. A textual analysis is performed on each extracted requirement. At S530, the extracted requirements are classified to produce distinct and optimized requirements respective thereof. The requirements classification is performed by the requirement analyzer 160 as discussed in detail above. It should be noted that the requirements that cannot be classified are identified, and the user (e.g., an IT architect) is prompted to provide the classification for the requirement (using the action items sub-module). The classifications provided by the user are learned by the analyzer 160 for further usage.

At S540, based on the distinct and optimized requirements, one or more design patterns are selected as discussed in detail above. At S550, the design patterns and classified requirements are provided to the solution repository 150, which links each requirement to its respective classified and optimized requirements as well as to at least one design dimension.

At S560, the complete design of the IT system is generated by the solution generator 130 and provided to the user for review and approval. As shown above, the complete design includes a simulation of the IT system where the user can view and operate the various screens of the IT system being designed. The user can also view and update requirements, database tables, the relation between different entities in the design, etc. In one embodiment, once the design produced by the tool is approved, detailed documents describing the system context diagrams, component models, and deployment models of the designed IT system are generated. It should be appreciated that such documents provide development and deployment engineers with all of the information required for successful development and deployment of the system.

The foregoing detailed description has set forth a few of the many forms that different embodiments of the invention can take. It is intended that the foregoing detailed description be understood as an illustration of selected forms that the invention can take and not as a limitation as to the definition of the invention.

Most preferably, the various embodiments discussed herein can be implemented as hardware, firmware, software, or any combination thereof. Moreover, the software is preferably implemented as an application program tangibly embodied on a program storage unit or computer readable medium. The application program may be uploaded to, and executed by, a machine comprising any suitable architecture. Preferably, the machine is implemented on a computer platform having hardware such as one or more central processing units (“CPUs”), a memory, and input/output interfaces. The computer platform may also include an operating system and microinstruction code. The various processes and functions described herein may be either part of the microinstruction code or part of the application program, or any combination thereof, which may be executed by a CPU, whether or not such computer or processor is explicitly shown. In addition, various other peripheral units may be connected to the computer platform such as an additional data storage unit and a printing unit. Furthermore, a non-transitory computer readable medium is any computer readable medium except for a transitory propagating signal.

What is claimed is:

1. A method for designing an information technology (IT) system, comprising:
receiving at least one requirement for the IT system;
receiving a layout of the IT system;
extracting the at least one requirement and the layout;
classifying the at least one requirement;
selecting a design pattern respective of each of the at least one classified requirement and the layout;
linking each of the at least one classified requirement to at least one design dimension;
producing an at least one complete design of the IT system; and
querying a user to determine whether the at least one complete design of the IT system has been approved by the user.

2. The method of claim 1, wherein extracting the at least one requirement and the at least a layout further comprises extracting information related to at least one of: entities, properties, meta-data, forms, commands, navigation, users, roles, authorizations, actions, and action items.

3. The method of claim 1, further comprising:
determining whether each of the at least one requirement is a distinct requirement, wherein the distinct requirement is a classified requirement being associated with only one design dimension; and
determining whether each of the at least one requirement is an optimized requirement.

4. The method of claim 1, wherein linking the at least one classified requirement to at least one design dimension further comprises:
linking at least one property of the at least one design dimension, wherein the at least one property is at least one of: type, sub-type, level, priority, origin, stage, span, amount, frequency, timing, input, output, mandatory, counter, activity, visibility, position, pointer, severity, probability, completeness percentage, approval status, and status.

5. The method of claim 1, further comprising:
upon receiving approval for the at least one complete design, generating detailed documents describing at least system context diagrams, component models, and deployment models.

6. The method of claim 1, further comprising:
communicating with an IT concept dictionary to create or maintain a hierarchical list of professional concepts, wherein the IT concept dictionary contains a glossary of professional concepts.

7. The method of claim 1, wherein the at least one requirement is classified as at least one of: hardware type, graphical user interface (GUI), database, training, and security.

8. The method of claim 1, further comprising:
generating at least displays of the IT system being designed in real-time.

9. The method of claim 8, wherein the at least displays of the IT system include any of: a simulation of the IT system, user experience and layout design modes, graphic dynamic displays and interfaces of navigation, menus and database design, hierarchical displays and interfaces of the at least one requirement, business vocabulary, actions, users, roles, and action items.

10. A design tool for designing an information technology (IT) system, comprising:
an interface configured to receive at least one input requirement and a layout of the IT system to be designed;
a processor;
a memory connected to the processor and configured to contain a plurality of instructions that, when executed by the processor, configure the system to:
extract the at least one requirement and the layout;
classify the at least one requirement;
select a design pattern respective of each of the at least one requirement and the layout;
link the at least one requirement to at least one design dimension; and
produce at least one optimized design pattern.

11. The design tool of claim 10, further comprising a solution repository containing at least logical connections between an input requirement and at least one design dimension.

12. The design tool of claim 10, wherein the system is further configured to:
determine whether each of the at least one requirement is a distinct requirement, and determine whether each of the at least one requirement is an optimized requirement, wherein the distinct requirement is a classified requirement being associated with only one design dimension.

13. The design tool of claim 10, wherein the system is further configured to:
generate detailed documents describing at least one of: system context diagrams, component models, and deployment models.

14. The design tool of claim 10, wherein the system is further configured to:
communicate with an IT concept dictionary to create or maintain a hierarchical list of professional concepts, wherein the IT concept dictionary contains a glossary of professional concepts.

15. The design tool of claim 10, further comprising at least one of: a generator, a knowledge extractor, a literal scanner, and a requirement analyzer.

16. The design tool of claim 15, wherein the knowledge extractor is configured to extract information related to at least one of: entities, properties, meta-data, forms, commands, navigation, users, roles, authorizations, actions, and action items.

17. The design tool of claim 15, wherein the generator is configured to at least generate displays and functions of the IT system being designed in real-time.

18. The design tool of claim 17, wherein the displays and functions of the information technology system may be any of: a simulation of the IT system, user experience and layout design modes, graphic dynamic displays and interfaces of navigation, menus and database design, hierarchical displays and interfaces of the at least one requirement, business vocabulary, actions, users, roles, and action items.

19. The design tool of claim 15, wherein the literal scanner is configured to at least perform a textual analysis of the at least one requirement.

20. The design tool of claim 15, wherein the requirement analyzer is configured to classified the at least one requirement as at least one of: hardware type, graphical user interface (GUI), database, training, and security.

21. A non-transitory computer readable medium having stored thereon instructions for causing one or more processing units to execute a process for designing an information technology (IT) system, comprising:
receiving at least one requirement for the IT system;
receiving a layout of the IT system;
extracting the at least one requirement and the layout;
classifying the at least one requirement;
selecting a design pattern respective of each of the at least one classified requirement and the layout;
linking each of the at least one classified requirement to at least one design dimension;
producing an at least one complete design of the IT system; and
querying a user to determine whether the at least one complete design of the IT system has been approved by the user.
